(19) United States
(12) Patent Application Publication
(10) Pub. No.: US 2018/0116241 A1
(43) Pub. Date: May 3, 2018

(54) BLENDED TEA BREWED BY USING MULTIPLE KINDS OF TEA LEAVES AND TEA BLENDED BY A TEA BLENDER

(71) Applicants: YEN QI CAI, JINJIANG CITY, FUJIAN PROVINCE (CN); SIU KAM CHOI, VALENZUELA CITY (PH)

(72) Inventors: YEN QI CAI, JINJIANG CITY, FUJIAN PROVINCE (CN); SIU KAM CHOI, VALENZUELA CITY (PH)

(21) Appl. No.: 15/572,759

(22) PCT Filed: Jun. 24, 2015
(86) PCT No.: PCT/CN2015/000443

§ 371 Date: Nov. 8, 2017

(30) Foreign Application Priority Data
May 20, 2015 (CN) 201510254655.6

(51) Int. Cl. A23F 3/14

(52) U.S. Cl. CPC A23F 3/14

(57) ABSTRACT

Disclosed is blended tea brewed by using two or more kinds of tea. The blended tea is brewed by adding one or more kinds of other tea leaves totally accounting for 30% to 45% in parts, on the basis of a kind of tea leaves accounting for 55% to 70% in parts.

### BACKGROUND

1. Technical Field

The present disclosure relates to the field of blending tea leaves.

2. Description of Related Art

China has long been considered the origin of tea, and the tea culture has a history of several thousand years. It is well-known that tea is of a great variety, but tea is traditionally brewed independently no matter being served as a beverage or used for medical purpose. Because tea leaves have variable characteristics depending on the variety and source, brewing methods are different. For example, the tea leaves of the fermented tea (black tea, partial hot nature), the semi-fermented tea (Tieguanyin, moderate property), and the non-fermented tea (green tea, cold nature) are blended so as to be well suitable for the requirements of different crowds. According to the perspectives of traditional Chinese medical science, various types of tea leaves have respective intrinsic qualities such as coldness, hot, warming, coolness, and each of the characteristics suits with different physical conditions of users. As a result, for high consumers of a single kind of tea drink, health risk cannot be ruled out. For example, the green tea belongs to coolness in nature, and would result in unfavorable impacts on persons who are prone to have cold-dampness in the stomach. It is preferably to add the black tea to the green tea if the cold stomach type people like the green tea. Thus, blending and brewing one or more kinds of other teas leaves can have a better effect on human health.

### SUMMARY

For the sake of overcoming the drawbacks associated with that teas which are independently brewed would cause negative physical reactions against human body, the primary purpose of the present disclosure is to provide a blended tea brewed by using multiple kinds of tea leaves and a tea blended by a tea blender which are brewed by adding one or more kinds of tea leaves to enhance tea flavors, increase depth of tea culture, and improve adverse impacts on human health, in which one or more (it is preferably to use two or three) kinds of teas leaves are brewed in percentage by weight. The blended tea and the tea blender provided in the present disclosure are the successful results produced through practical implementations, accumulation of experiences and empirical data and broad comparisons in many years. In addition, by virtue of a blended tea brewed by using multiple kinds of tea leaves and a tea blended by a tea blender provided by the present disclosure, groups of tea consumers can be increased and performance of human health can be improved.

### DESCRIPTION OF THE EXEMPLARY EMBODIMENTS

Currently, blended teas are brewed by using different kinds of tea leaves commercially available as the raw material and blended in percentage by weight. Teas of different varieties, however, have respective innate characters and distinctive flavors. From the point of view of traditional Chinese medical science, tea is intrinsically cold. In addition, the tea saint Lu Yu said “Tea is quite suitable as drink for the nature of coldness” in his grand work “The Classic of Tea”. As manufacturing methods of tea, such as baking and fermenting, advance with the times, tea is evolved into hot in property.

Generally, a blended tea is named after the type of a tea having a larger proportion mixed in the blended tea. For example, a blended black tea in which the main component tea such as Da Hong Pao (Big Red Robe) accounting for 55-70% is adopted and the other component tea accounting for 30% to 45% is adopted is named as Da Hong Pao (Big Red Robe) blended tea. Similarly, a blended tea in which Longjing tea (Dragon Well tea) or Tieguanyin (Iron Goddess) of a proportion accounting for 55-70% which is larger than a proportion of green tea mixed therein is adopted is named as Longjing tea (Dragon Well tea) blended tea or Tieguanyin (Iron Goddess) blended tea. If multiple kinds of tea leaves are mixed in a package, each tea component and content are supposed to be noted on the package so as to bring greater convenience to selection and use of consumers. In addition, the teahouse is obligated to let the consumer know tea components.

1. A blended tea brewed by using two or more kinds of tea, wherein the blended tea is brewed by adding one or more kinds of other tea leaves totally accounting for 30% to 45% in parts, on the basis of a kind of tea leaves accounting for 55% to 70% in parts.

2. The blended tea according to claim 1, wherein the blended tea in which the main component tea selected from Tieguanyin accounting for 55-70% is adopted is named as a Tieguanyin blended tea.

3. The blended tea according to claim 2, wherein if a package contains multiple kinds of tea leaves, each tea component is noted on the package; wherein a teahouse makes a user know each tea component, and the blended tea is brewed by a tea blender.

4. The blended tea according to claim 3, wherein a tea brewer brewing the blended tea is the tea blender, a tea blender is different from a tea taster, and tea blenders are trained from tea tasters.

5. The blended tea according to claim 4, wherein the blended tea is brewed by the tea blender and the tea blender is trained to brew the blended tea based on different tastes and appetites of users and people with different constitutions.

6. The blended tea according to claim 5, wherein the tea blender is trained to blend tea with other foods, Chinese medicinal herbs or a combination thereof

7. The blended tea according to claim 6, wherein teas comprising officinal components such as midday teas, medicated leaves, and wanying medicinal teas are added to the blended tea by the tea blender for the health protection and medical treatment.

8. The blended tea according to claim 7, wherein the tea blender employs tea leaves originated from different regions to brew the blended tea, and users drink the blended tea mixed with multiple kinds of tea leaves and components each time, daily or weekly according to personal preference.
